(19) United States
(12) Patent Application Publication
(10) Pub. No.: US 2010/0050901 A1
(43) Pub. Date: Mar. 4, 2010

(54) Multi-level anticounterfeit, security and detection taggant

(76) Inventors: Alexandru S. Biris, Little Rock, AR (US); Enkeleda Dervishi, Little Rock, AR (US)

Correspondence Address: WRIGHT, LINDSEY & JENNINGS LLP, 200 WEST CAPITOL AVENUE, SUITE 2300, LITTLE ROCK, AR, 72201-3699, US

(21) Appl. No.: 12/583,431

(22) Filed: Aug. 20, 2009

Related U.S. Application Data
(60) Provisional application No. 61/190,936, filed on Sep. 4, 2008.

(51) Int. Cl. C09D 11/00

(52) U.S. Cl. 106/31.14; 523/161

(57) ABSTRACT

Various complex structures (nano/micro particles) are incorporated into a taggant providing different optical, magnetic and spectroscopic identification codes. The size and shape of the taggant can be tailored for many different types of products ranging from pharmaceuticals, auto and airplane parts all the way to apparel goods. By integrating a number of different nano/micro structures with various optical, electrical and magnetic properties, significant barriers are introduced to the counterfeiters attempting to replicate the taggant. The latter is easily incorporated to different types of products and is detected with various types of handheld readers/detectors depending on the complexity of the security level. The taggant may detect environmental materials or conditions.

### CROSS-REFERENCE TO RELATED APPLICATIONS

This application claims the benefit of U.S. Provisional Patent Application No. 61/190,936 filed Sep. 4, 2008, the disclosure of which is incorporated herein by reference in its entirety.

### STATEMENT REGARDING FEDERALLY SPONSORED RESEARCH OR DEVELOPMENT

Not applicable.

### BACKGROUND OF THE INVENTION

1. Field of the Invention

The present invention relates to multi-level materials, and in particular, to anticounterfeit, security and detection taggants employing such materials.

2. Brief Description of the Related Art

Counterfeiting has been a problem for many years in today's society and lately it has been increasing at an alarming rate. Different types of products ranging from pharmaceuticals, auto and airplane parts and all the way to apparel goods are counterfeited on daily basis. Knock-off versions of real products that are being sold on the markets are at a much lower quality impacting the health and security of the public. Many anticounterfeit devices have been designed and are available in the market, but none of them are completely successful in stopping counterfeiting. The reason is because these types of security taggants can be easily replicated by the counterfeiters, thus defeating the purpose of integrating an anticounterfeit tag into the authentic product. For example, taggants involving hologram and phosphorus technology are not complex enough and as a result are often replicated by the counterfeiters. Hologram taggants can be easily reproduced as devices such as printers and scanners become more sophisticated. More advanced security devices involve quantum dots embedded into a polymer layer as described in U.S. Pat. No. 6,692,031 to McGrew. This device only provides one level of authentication (optical verification), hence making the taggant still vulnerable for the counterfeiters to replicate. These types of anticounterfeit taggants have to be constantly changed to stay one step ahead of counterfeiters. Consequently, there is a vital need for a robust multi-layered anticounterfeit/security taggant. This invention describes an anticounterfeit taggant that is not economically feasible for the counterfeiters to replicate and at the same time it provides multi-level security.

It is also desirable for security purposes to detect environmental materials and conditions; for example, the presence of explosive materials.

### BRIEF SUMMARY OF THE INVENTION

The present invention utilizes a wide variety of nanomaterials, micro materials and bulk materials that are all integrated into a taggant to provide the taggant with spectroscopic, magnetic, optical and/or electrical properties. All these properties may be integrated individually or in combination into the taggant. The properties may be manipulated to provide unique signatures that are detectable by various modes of detection. For example, the detection may be carried out by means of optical processes, Raman Spectroscopy, FTIR, magnetic measurements and/or electrical measurements. In one embodiment, the taggant becomes optically active under electrical, optical or magnet excitation. The taggant may be utilized to protect against the counterfeiting of different types of products. The multi-component taggant has a plurality of different types of nano/micro particles and bulk materials including but not limited to: carbon nanotubes, magnetic nanomaterials coated by various other materials (graphitic carbon, polymers, DNA, proteins, etc.), quantum dots, calcium carbonate, hydroxyapetite (nanocrystals), silver nanoparticles, DNA and biological systems. For example, carbon nanotubes (CNTs) and quantum dots with various dimensions may be added to enhance the complexity of the taggant (also called herein a “nano-tag”) by creating complex signatures that are difficult to reproduce. This complex authentication nano-tag is designed in such a way that it will not be economically feasible for counterfeiters to reproduce.

The size of the taggant may be varied and customized for a particular product that the multi-layered complex nano-tag is applied to. In one embodiment, combinations of different types of nano/micro/bulk particles can be embedded onto or into a thin polymer layer. The polymer layer may have an adhesive backing to allow for fast and easy application to a wide variety of products. In another embodiment, the combinations of different types of nano/micro/bulk particles may be incorporated into an “ink” that is deposition or sprayed onto a product. The taggant can be designed to be more complex by adding to the number of different types of nano/micro/bulk structures. By controlling the shape and size of these structures, one can control their optical, magnetic, electrical and spectroscopic properties, thus generating unique identification codes.

The taggant may have the capability to detect gaseous, acoustic, liquid or solid materials or conditions in the environment of the taggant. These detection functions may be combined with anticounterfeit functions in the taggant or the anticounterfeit functions may not be present in the taggant.

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 shows a top view of a complex multi-layered taggant, where different types of nano/micro/bulk particles are incorporated into or onto a thin polymer layer.

FIGS. 2A and 2B show side views of an embodiment of a taggant. In this embodiment, nano/micro/bulk particles are deposited on top of a thin polymer layer and an adhesive backing is integrated at the bottom of the taggant.

### DETAILED DESCRIPTION OF THE INVENTION

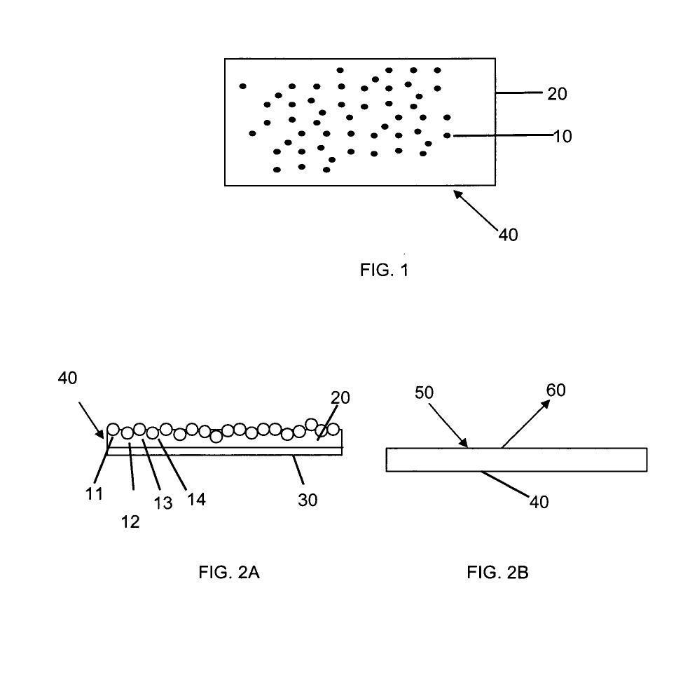

Embodiments of the present invention are described as follows with reference to FIGS. 1, 2A and 2B.

### Structure of the Taggant

Various types of nano/micro/bulk particles may be incorporated in various ways into a matrix (for example, a natural material or a synthetic polymer) that is preferably chemically and thermally stable to form the taggant. The taggant can be designed in such a way that the various structures in the matrix may or may not be detectable by the human eye. A plurality of different classes of materials (an example using four types of nano/micro/bulk particles 11, 12, 13, 14 is shown in FIG. 2A) can be incorporated into the taggant 40. Each class of materials is characterized by a different signature that can be detected by a mode of detection. The different classes of materials can be functionalized in order to increase the dispersion and to bind them to other materials or polymers.

For the particular embodiment of the taggant 40 shown on FIG. 1, the taggant 40 may be manufactured as follows. Materials 10, including nano, micro or bulk particles, are first dispersed into a carrier, such as a solvent, and then mixed into a polymer and strongly sonicated with a high power sonicator. Some nanomaterials may require further treatment in order to disperse them in the carrier. For example, a solution of nanomaterials, sodium cholate and water may be prepared in order to homogeneously disperse some nanomaterials in water. In order to disperse some nanomaterials, such as carbon nanotubes (CNT's), which are very hydrophobic in water and due to the van der Waals forces tend to agglomerate into bundles, a surfactant such as sodium cholate, which is hydrophilic, is required for a homogeneous dispersion of the CNTs into water. Other solvents include polar and non-polar organic solvents. Other nano/micro particles might not require a surfactant in order to dissolve or evenly disperse in water. Other treatments may include plasma treatment, UV treatment or the like. Once a homogeneous solution of particles is achieved there are several ways that this solution may be integrated into a polymer layer:

In one embodiment, a nano/micro particle solution can be mixed with a polymer when the later is in a liquid state, then strongly sonicated for a good dispersion of the particles into the polymer. The final solution is poured onto a Teflon surface (it is not limited to this surface, others can be used) to form a thin composite polymer layer 20. For example, poly(methyl methacrylate) (PMMA) is only one example among many other polymers that could be used when designing this type of taggant.

If the polymer is in a liquid state, a set amount is poured onto a Teflon foil. The nano/micro particle solution can be deposited on top of the polymer layer while is it still in liquid form or after it has dried into a thin uniform layer. The deposition of the particle solution can be achieved through an electro-spray or printing method.

In either case, the final nano-composite polymer layer 20 is allowed to air dry and is then peeled off and attached to the desired product through an adhesive backing 30 or other methods known to those skilled in the art to form the completed taggant 40.

Integration of the Taggant into the Product

The matrix that the different classes of materials are incorporated into may include various forms. The matrix of the taggant 40 can be, but is not limited to, the form of: a polymer nano-composite layer, inks, and thin transparent films with adhesive backing. The taggant can be applied to the product in various ways such as:

The taggant 40 in the form of an “ink solution” is mixed with the components of the product itself while being manufactured or produced. For example, the final product can be sprayed with, or dipped into the “ink solution”. An electro-spray technique can be used to uniformly deposit the “ink solution” onto the desired product. In addition, the “ink solution” can be deposited on the surface of the product through a simple printing method.

As note above, if the taggant 40 is in the form of a thin nano-composite polymer layer 20, it can be attached onto the surface of the desired product through an adhesive backing 30 or other ways known to those skilled in the art.

The taggant 40 may also be integrated into a bar code label.

These are only some of the methods through which the security taggant 40 is integrated onto or into different types of products, but it is certainly not limited to the methods described herein, as other ways known to those skilled in the art exist.

### Authentication Methods for the Taggant

As shown in FIG. 2B, the taggant 40 may be authenticated through various modes of detection 50 that could include stimulating the taggant by various interrogation means, such as laser, optical, electrical or magnetic means and detecting the signature 60 by various means, including spectroscopic, optical, magnetic and electrical means. It is preferable that at least two of the signatures 60 be invisible to detection by direct human sensing. For rapid and simple verification, a handheld ultraviolet (UV) light can be used to verify the taggant 40. For a more thorough authentication, highly complex handheld instruments should be exploited. The different types of nano/micro/bulk particles present in the taggant allow it to be dynamic, in that the anticounterfeit nano-tag is capable of being verified on multiple levels such as optical and spectroscopic verification. For example, if the taggant is integrated into a bar code label, a bar code reader may also include an hand-held spectrometer for verification.

The nano/micro/bulk particles utilized in the taggant have various physical and chemical properties that produce a unique signature under various modes of detection. For example, an ultraviolet (UV) light will trigger a fluorescent response from nano particles (quantum dots), and the signature will vary depending on the varying dimensions of the nano particles. When quantum dots are utilized as fluorescent taggants, the taggant can thus be optically authenticated. Depending on their sizes, composition and structure, quantum dots fluoresce in different colors providing a unique identification code. The different type and sizes of the quantum dots can be mixed and rearranged in such a way that an extremely large variety of distinctive authentication codes can be generated. Similarly, fluorescent properties may be incorporated into the taggant using fluorescent dyes. Also, particles having other properties, such as magnetism, may be coated with fluorescent materials.

Some particles may have thermal properties so that when excited, for example optically, give off a thermal signature that can be detected by an infrared (IR) camera.

A handheld spectroscopic device with a quick time response can be used to detect the presence of particles present in the taggant. Raman spectroscopy is a very powerful and sensitive technique used to characterize different types of materials. Since each nano/micro particle gives a unique Raman spectrum or has a so called specific “fingerprint” region, Raman Spectroscopy is an ideal technique to authenticate a taggant incorporating nano/micro particles. By varying the concentration, the size and the amount of nano/micro particles, one can generate an extremely large number of Raman spectrums that would be virtually impossible for counterfeiters to reproduce, hence making it practically impossible to replicate the taggant. Each Raman spectrum effectively represents a unique identification code present in the taggant.

In addition, a detection instrument may provide a code/color detection which demonstrates if the taggant is authentic or has been tampered with. The spectroscopic instrument may compare the observed spectrum from a taggant with a stored authentic spectrum. For example, the spectroscopic instrument may use the colors green/red (on the device) to indicate if the taggant is authentic/not authentic respectively. Such verification can be accurately achieved in a matter of minutes.

Therefore, the taggant of the present invention can be easily and quickly verified by a simple instrument, for example, a small UV light, as well as a more complex handheld instrument, such as a Raman spectroscope. The complex nano-tag of the present invention is customizable, inexpensive and amendable to mass production. In addition, it has a variety of applications—it is capable of horizontally spreading across different industries, with only minor changes taking place to the design of the taggant. The size and structure of the taggant can be changed depending on the properties of the surface of the product it will be applied to.

The taggant may be provided with the capability to detect gaseous, acoustic, liquid or solid materials or conditions. These detection functions may be associated with anticounterfeit functions in the taggant or the anticounterfeit functions may not be present.

The nanomaterials incorporated into the taggant could include carbonaceous nanostructures (carbon nanotubes with one, two or multiple walls, nanofibers, graphene layers, or graphite), metal nanoparticles (Au, Ag, Ti, etc.), metal oxides, ceramics, polymeric nanostructures and/or a combination of such materials or classes of materials. In one embodiment, Ag or Au nanomaterials may be coated onto the surface of other structures or nanostructures in the taggant in such a combination that they will provide spectroscopic enhancement of the signal (Surface Enhanced Spectroscopy).

Under the right stimulation (electrical, magnetic, acoustical or optical), the system will provide a detectable signal that is unique and can be associated with a particular product. These structures may be functionalized with various functional groups such as NO₂, NH₃, COOH, or the like. The nanostructures may be in intimate contact with polymeric structures and/or organic dyes. Under the right electrical, optical or magnetic stimulation, there is a charge transfer from environmental materials such that parts or the whole system will respond optically. The system, composed of one or a multitude of components, therefore acts as a detector for other materials or conditions (gaseous, acoustic, liquid or solid) such as organic and non-organic structures and produces a detectable signal. This can occur under electrical, optical, or magnetic stimulation.

All these systems may be placed on the outside of a product or may be incorporated into the product. These systems can be used inside public or commercial places for detection of organic/inorganic molecules. They can also be placed in transportation vehicles or containers.

The present invention has been described with reference to certain preferred and alternative embodiments that are intended to be exemplary only and not limiting to the full scope of the present invention as set forth in the appended claims.

What is claimed is:

1. A taggant, comprising:
a first class of material characterized by a first invisible signature detectable by a first mode of detection;
a second class of material characterized by a second invisible signature detectable by a second mode of detection that is different than said first mode of detection; and
a matrix carrying said first class of material and said second class of material.

2. The taggant of claim 1, wherein said first class of material is selected from the group consisting of nanomaterials, micromaterials and bulk materials.

3. The taggant of claim 1, wherein said first signature is selected from the group consisting of spectroscopic, magnetic, optical and electrical properties.

4. The taggant of claim 1, wherein said first mode of detection is selected from the group consisting of optical processes, Raman spectroscopy, FTIR, magnetic measurements and electrical measurements.

5. The taggant of claim 1, wherein said first class of material is optically active when excited by an excitation selected from the group consisting of electrical, optical and magnet excitation.

6. The taggant of claim 1, wherein said first class of material is selected from the group consisting of carbon nanotubes, quantum dots, calcium carbonate, hydroxyapetite nanocrystals, silver nanoparticles and magnetic nanomaterials coated by a coating material selected from the group consisting of graphitic carbon, polymers, DNA and proteins.

7. The taggant of claim 1, wherein said second class of material is selected from the group consisting of nanomaterials, micromaterials and bulk materials.

8. The taggant of claim 1, wherein said second signature is selected from the group consisting of spectroscopic, magnetic, optical and electrical properties.

9. The taggant of claim 1, wherein said second mode of detection is selected from the group consisting of optical processes, Raman spectroscopy, FTIR, magnetic measurements and electrical measurements.

10. The taggant of claim 1, wherein said second class of material is optically active when excited by an excitation selected from the group consisting of electrical, optical and magnet excitation.

11. The taggant of claim 1, wherein said second class of material is selected from the group consisting of carbon nanotubes, quantum dots, calcium carbonate, hydroxyapetite nanocrystals, silver nanoparticles and magnetic nanomaterials coated by a coating material selected from the group consisting of graphitic carbon, polymers, DNA and proteins.

12. The taggant of claim 1, wherein said matrix is selected from the group consisting of a polymer and an ink.

13. The taggant of claim 12 wherein said matrix is a thin polymer layer.

14. The taggant of claim 13, wherein said first class of material and said second class of material are embedded onto said layer.

15. The taggant of claim 13, wherein said first class of material and said second class of material are embedded in said layer.

16. The taggant of claim 13, wherein said thin polymer layer is transparent.

17. The taggant of claim 13, wherein said thin polymer layer comprises an adhesive backing.

18. The taggant of claim 1, further comprising means for detecting an environmental material.

19. A taggant for detecting an environmental material, comprising:
a nanomaterial functionalized with at least one functional group that accepts charge transfer from the environmental material under stimulation by an external stimulation;
wherein said nanomaterial is in contact with a structure that produces a detectable signal upon charge transfer.

20. The taggant of claim 19, wherein said nanomaterial is selected from the group consisting of carbonaceous nanostructures, metal nanoparticles, metal oxides, ceramics, polymeric nanostructures and a combination of any of the preceding.

21. The taggant of claim 20, wherein said carbonaceous nanostructures are selected from the group consisting of carbon nanotubes, nanofibers, graphene layers and graphite.

22. The taggant of claim 19, further comprising a surface coating on said nanostructures, said surface coating selected from the group consisting of silver and gold.

23. The taggant of claim 19, wherein said functional groups are selected from the group consisting of NO₂, NH₃ and COOH.

24. The taggant of claim 19, wherein said external stimulation is selected from the group consisting of electrical, magnetic, acoustic or optical stimulation.

25. The taggant of claim 19, where said structure that produces a detectable signal upon charge transfer is selected from the group consisting of polymeric structure and organic dyes.

26. The taggant of claim 19, further comprising means for anticounterfeiting.
